(19) United States
(12) Patent Application Publication
(10) Pub. No.: US 2009/0268065 A1
(43) Pub. Date: Oct. 29, 2009

(54) CMOS LINEAR IMAGE SENSOR OPERATING BY CHARGE TRANSFER

(75) Inventor: Pierre Fereyre, Voreppe (FR)

Correspondence Address: LOWE HAUPTMAN HAM & BERNER, LLP, 1700 DIAGONAL ROAD, SUITE 300, ALEXANDRIA, VA, 22314, US

(73) Assignee: E2V Semiconductors, Saint Egreve (FR)

(21) Appl. No.: 12/440,681

(22) PCT Filed: Aug. 17, 2007
(86) PCT No.: PCT/EP2007/058549

§ 371 Date: Apr. 21, 2009

(30) Foreign Application Priority Data
Sep. 19, 2006 (FR) 06 08188

(51) Int. Cl. H04N 5/335

(52) U.S. Cl. 348/294; 348/E05.024

(57) ABSTRACT

The invention relates to image sensors in the form of a signal-integrating, travelling multi-line linear array for the synchronized readout of one and the same linear image successively by N lines of P photosensitive pixels and the pixel by pixel summation of the signals read out by the various lines. At the start of a photogenerated-charge integration time, the output voltage of a pixel of a previous line of rank i−1 is applied to the photodiode of the pixel of an intermediate line of rank i, the photodiode is isolated, the charges due to light are integrated therein and, finally, at the end of the integration time, the charges of the photodiode are transferred to a storage node of the pixel. A charge-voltage conversion circuit transforms the charges of the storage node into an output voltage of the pixel. Thus, before photogenerated charges are integrated in each pixel, a charge equivalent to an aggregate of charges originating from the previous pixel lines that have observed the same line of a scene is decanted into the photodiode.

### CROSS-REFERENCE TO RELATED APPLICATIONS

The present application is based on International Application No. PCT/EP2007/058549, filed on Aug. 17, 2007, which in turn corresponds to French Application No. 06 08188, filed on Sep. 19, 2006, and priority is hereby claimed under 35 USC §119 based on these applications. Each of these applications are hereby incorporated by reference in their entirety into the present application.

### FIELD OF THE INVENTION

The invention relates to travelling and signal-integrating type linear image sensors (or TDI sensors, standing for: “Time Delay Integration Linear Sensors”), in which an image of a line of points of an observed scene is reconstituted by adding together successive images taken by several photosensitive lines successively observing one and the same line of the scene as the scene travels past the sensor.

### BACKGROUND OF THE INVENTION

These sensors are used for example in scanners. They comprise an array of several parallel lines of photosensitive pixels; the sequencing of the control circuits for the various lines (control of time of exposure and then of readout of the photogenerated charges) is synchronized with respect to the relative travel of the scene and of the sensor, in such a manner that all the lines of the sensor see a single line of the observed scene. The signals generated by each line are thereafter added together point-by-point for each point of the observed line.

The signal/noise ratio is improved in the ratio of the square root of the number N of lines of the sensor. This number N can be for example 16 or 32 for industrial control applications or applications of Earth observation from space, or even from 60 to 100 lines for medical applications (dentistry, mammography, etc.).

In charge transfer image sensors (CCD sensors), the addition of the signals point by point was done simply by draining in a line of pixels the charges generated and accumulated in the previous line of pixels, in synchronism with the relative displacement of the scene and sensor. The last line of pixels, having accumulated N times the charges generated by the observed line, was thereafter able to be transferred to an output register and converted, during a readout phase, into electrical voltage or current.

Image sensor technology has thereafter evolved towards sensors with active pixels with transistors, that hereinafter will be called CMOS sensors for simplicity since they are generally produced using CMOS (complementary-metal-oxide-semiconductor) technology; in these CMOS sensors there is no longer any transfer of charges from line to line towards a readout register but there are active pixels with transistors which gather photogenerated electrical charges and convert them directly into a voltage or current. The various lines of the sensor therefore successively provide voltages or currents representing the illumination received by the line. These currents or voltages cannot easily be added up; it is therefore difficult to produce a travelling and charge integration sensor.

Attempts have however been made to produce CMOS travelling and charge integration sensors.

The use has been tried in particular of switched capacitors in which successive currents received are integrated, thus accumulating on one and the same capacitor charges received from several pixels column-wise.

The systems thus tried are not satisfactory and are difficult to produce.

### SUMMARY OF THE INVENTION

According to the invention, it is proposed to profit from the fact that the active pixels of image sensors using CMOS technology usually comprise two mutually isolated sites, in which the photogenerated charges can be momentarily stored; these sites are on the one hand the photodiode in which charges are generated under the effect of light, and on the other hand an intermediate storage node which receives the charges of the photodiode at the end of a charge integration period and which thereafter serves for the production of an output voltage of the pixel; the pixel output voltage is related to the quantity of charge present on the storage node. This decomposition of the pixel into two different charge storage sites is normally related to the necessity to read line by line the signals of the various pixels of a matrix of N lines, this readout generally being done from the storage nodes during a new integration of charges in the photodiodes.

This type of structure is used here in a very different manner, in a context of TDI sensors where no line by line readout will be done, but only a readout of the sum of N lines having observed one and the same image line.

There is therefore proposed a method of image capture, of the travelling and signal-integrating type, for the synchronized readout of one and the same image line successively by N lines of P photosensitive pixels and the pixel by pixel summation of signals arising from the readout of the various lines, during successive integration periods, in correspondence with the travelling of the linear image past the N lines of pixels, a pixel being built up of a circuit with MOS transistors comprising at least one photodiode, a charge storage node, and a charge-voltage conversion circuit for applying a voltage representing the quantity of charge stored in the storage node to an output of the pixel, characterized in that, at the start of an integration time for integrating photogenerated charges, the output voltage of a pixel of a previous line is applied to the photodiode of the pixel of an intermediate line of rank i, the photodiode is isolated, charges due to light are integrated therein, and finally, at the end of the integration time, the charges of the photodiode are transferred into the storage node.

Thus, the charge decanted into the storage node will practically be the sum of the charges due purely to the illumination of the photodiode and of an initial charge which has been built up on the basis of the charge stored in the storage node of the pixel of the previous line; the latter charge is itself an aggregate of photogenerated charges and of an initial charge arising from a yet previous line, and so on and so forth. For N sensor lines thus linked together, the charge decanted into the storage node of a pixel of the last line will be equivalent to an aggregate of charges photogenerated in the N lines which have observed one and the same image line. It is the latter charge which will be converted into voltage to provide an electrical representation of the image line observed successively by the N lines.

Unlike TDI sensors of CCD type, here there is no actual decanting of charges from a pixel into a pixel of a following line, but there is build-up of an initial charge in the photodiode of a pixel, before integration of charges due to light, and this build-up of charge is effected by applying a voltage representing the charges of the previous pixel to the photodiode.

Preferably, the charge of the storage node is reinitialized to a fixed value before the charges are transferred from the photodiode into this storage node.

The circuit which converts the charges of the storage node into voltage can comprise a first follower transistor whose gate is linked to the storage node and whose source is connected to a current source; the reinitialization of the charge of the storage node is performed by linking the node to a reference voltage (Vref) whose value is preferably equal to the sum of the gate-source voltage drop of the first follower transistor and of the voltage (termed the “pedestal voltage”) appearing across the terminals of the photodiode when the latter is empty of charges and isolated.

If it is desired that the sensor operate with a variable duration of exposure Te in the course of the charge integration period T, there is provision for the method to comprise a step of connecting the diode to a power supply potential (Vdd) before the application to the photodiode of the output voltage of the pixel of the previous line, so as to link the photodiode to the potential of this power supply during a fraction of the charge integration period T and prevent during this fraction the integration of charges in the photodiode.

In addition to the method which has just been summarized, the invention proposes a linear image sensor, of the travelling and integration type, allowing the synchronized readout of one and the same linear image successively by N lines of P photosensitive pixels and the pixel by pixel summation of signals arising from the readout of the various lines, during successive integration periods, in correspondence with the travelling of the linear image past the N lines of pixels, a pixel being built up of a circuit with MOS transistors comprising at least one photodiode, a charge storage node, an on/off switch for transferring the charge of the photodiode to the storage node at the end of an integration period, an on/off switch for reinitializing the charge of the storage node before this transfer, and a charge-voltage conversion circuit for applying a voltage representing the charge stored on the storage node to an output of the pixel, characterized in that a pixel of rank j in a line of intermediate rank i has its output linked to an input of the pixel of rank j of the line of immediately higher rank i+1, and comprises an input linked to an output of the pixel of rank j of the line of immediately lower rank i−1, with an on/off switch between the input and the photodiode for applying to the photodiode, before charge integration, the voltage present at the input of the pixel.

The pixel can comprise a transistor for adjusting the duration of exposure, linked between the photodiode and a power supply voltage (Vdd) so as to link the photodiode to the potential of this power supply during a fraction of the charge integration period and prevent during this fraction the integration of charges in the photodiode.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 represents a general diagram of a TDI sensor allowing operation according to the method of the invention;

FIG. 2 represents the make-up of an active pixel usable to implement the invention;

FIG. 3 represents a chart of control signals for the sensor using the pixel of FIG. 2.

### DETAILED DESCRIPTION OF THE INVENTION

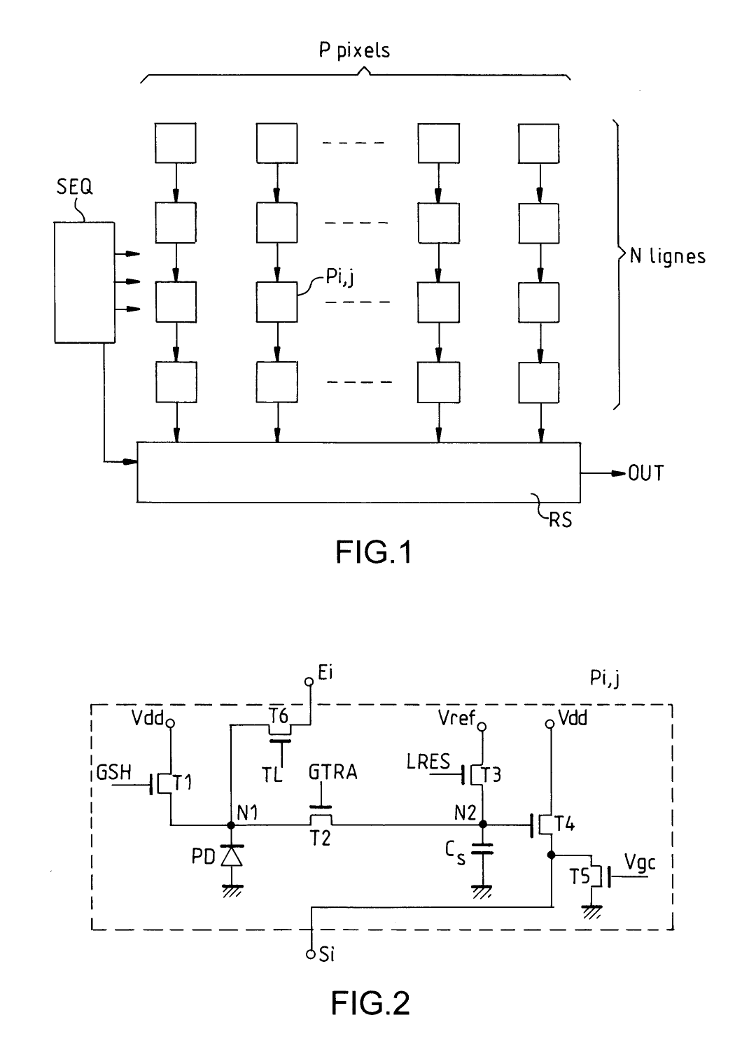

The principle of a sensor implementing the invention is shown diagrammatically in FIG. 1. This travelling and integrating linear image sensor or TDI sensor comprises N lines of P pixels, the pixel of rank j of an intermediate line of rank i being denoted by P_{i,j}; i is an integer index varying from 1 to N and j is an integer index varying from 1 to P.

The pixels are active pixels each comprising a few MOS transistors controlled by control signals. The control signals are global (control of all the pixels at one and the same time); it will be noted that it is not necessary in principle to provide control signals assigned to one line at a time as is generally the case in CMOS matrix sensors with N lines of P pixels.

The principle of the active pixel with MOS transistors that will be used in this TDI sensor is in a general manner the following: during an integration time all the pixels integrate in a photodiode (which, in a conventional matrix would previously be drained of its charges but which according to the invention is filled with an initial charge) the charges which are produced by light; then the charge of the photodiode is decanted into a charge storage node of the pixel which has been reset to zero before this decanting; then, the charge of the storage node is converted into current or into voltage and applied to an output conductor, in general by a transistor arranged as a voltage follower. In a conventional CMOS pixel type matrix, the output conductor is a column conductor common to all the pixels of one and the same column and the pixels are read out line by line in such a manner that the column conductors receive the voltage generated by the storage nodes of a single line of pixels; this readout is done during a new integration time for charges in the photodiodes which are then isolated from the storage nodes.

According to the invention, and as may be seen in FIG. 1, there is no column conductor. The output voltage of a pixel P_{(i-1),j} of rank j of the line of rank i−1, representing the charge accumulated on the storage node of this pixel at the end of a first integration period, is applied to the pixel P_{i,j} of rank j of the line of rank i with a view to the second integration period. More precisely, this output voltage of the pixel P_{(i-1),j} is applied to the photodiode of the pixel of the line of rank i at the start of the integration time of the second period and it causes the initialization in the photodiode of an initial quantity of charge proportional to this voltage. The photodiode will therefore, in the course of the integration time, accumulate a charge which is the sum of this initial charge and of a new photogenerated charge. At the end of the second integration period, it is this sum which will serve to generate an output voltage for the pixel of the line of rank i; the latter serves in the course of the third integration period to define the initial charge of the photodiode of the pixel P_{(i+1),j} of the following line. And so on and so forth.

The integration periods are synchronized with the travel of the image, in such a manner that, during an integration period, the line of rank i integrates charges photogenerated by the same line of a scene which was observed by the line of rank i−1 during the previous integration period. Stated otherwise, for the duration T of a charge integration period, the relative displacement of the image projected on the sensor is equal to the spacing of the pixel lines.

Thus, the last line of pixels will ultimately receive on the charge storage node of each pixel a quantity of charge which will be the result of an accumulation of charges generated by all the pixel lines while they were observing one and the same image line. It will be seen further on that this accumulation is not necessarily the exact sum of the charges of each line, this being so for reasons involving notably gains that are not unitary during transfers or charge-voltage conversions; but the result of this accumulation is very close to that of sensors of the travelling and charge integration type and it affords the same advantages, namely a significant improvement in the signal/noise ratio; the improvement is practically in a ratio equal to the square root of the number of lines N.

A sequencer SEQ manages the succession of the control signals for the pixels. A concrete example of control signals will be given hereinafter. An output register RS (which can be a multiplexer) receives the output voltages of the last line of pixels (of rank N) and provides on an output OUT the analogue voltages originating from the latter line, or else digital voltages if the register comprises one or more analogue-digital converters.

FIG. 2 represents the implementation of the invention in the case where the structure of the pixel is inspired by pixels with five transistors of known type used in CMOS matrices.

The pixel modified according to the invention comprises six MOS transistors T1 to T6 and a photodiode PD.

The photodiode PD is connected in series with the transistor T1 between an earth and a power supply voltage Vdd. The transistor T1 can be turned on, for resetting the charges of the photodiode to zero, by a general reset to zero signal GSH simultaneously acting on all the pixels of the matrix before the start of an integration time. The global control GSH makes it possible to adjust the exposure time Te within the charge integration period T since the photodiode cannot integrate charges as long as the transistor T1 is turned on. This transistor T1 is optional if it is not desired to adjust the exposure time. It can also serve as anti-dazzle drain.

Node N1 linking the photodiode and the transistor T1 accumulates charges in the course of the integration time. This node N1 can be linked briefly to a charge storage node N2 by the transistor T2, at the end of an integration time, by a transfer control signal GTRA acting simultaneously on all the pixels of the matrix.

The storage node N2 can be reset to a reference potential Vref (reinitialization of the charges of node N2) by the transistor T3 which receives a brief control signal LRES common to all the pixels. The signal LRES is emitted at the end of each integration time, before the emission of the signal GTRA.

Node N2 is additionally linked to a charge-voltage conversion circuit comprising in this example two transistors T4, T5. More precisely, node N2 is linked to the gate of the follower transistor T4 whose drain is at the potential Vdd and whose source copies over (to within a gate source voltage drop) the potential taken by the gate, that is to say the potential of the storage node N2. The source of the transistor T4 is linked to an output Si of the pixel P_{i,j} and it is this output which will be linked to the input (Eᵢ₊₁) of the pixel of rank j of the following line. A transistor T5, having its gate brought to a fixed potential Vgc common to all the pixels of the N lines, constitutes a current source connected between the source of T4 and earth so that the transistor T4 does indeed operate in follower mode. Together T4 and T5 form a voltage follower circuit establishing on the source of T4 a voltage which copies over, to within the gate-source voltage (Vgs) of the transistor T4, the voltage present on the storage node.

Finally, a transistor T6, turned on by an interline transfer signal TL, global for all the pixels of the N lines, makes it possible to link an input Eᵢ of the pixel P_{i,j} to the node N1 of the photodiode PD.

A capacitor Cs has been represented, linked between node N2 and earth; it can consist of plates intentionally constructed in capacitor form, or of stray capacitors present between node N2 and earth. It is this which allows node N2 to act as charge storage node.

Detailed Operation of the Pixel:

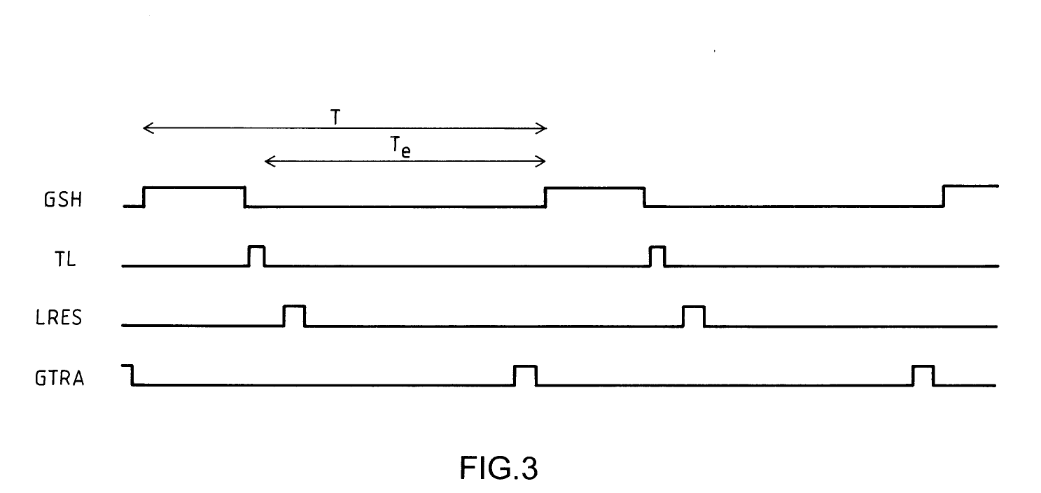

To describe the operation of the circuit, the chronology of the signals at each new charge integration period will firstly be described; it is recalled that the value T of the period is synchronized with the relative displacement of the sensor and of the observed image, and it is such that an image line moves by a line of pixels on the sensor in the course of a period T; the chronology is as follows and may be seen in FIG. 3:
emission of a general signal GSH for defining the duration of exposure Te, that is to say the charge integration time inside the period T; this signal fixes the potential of the photodiode at Vdd and prevents any accumulation of charges (electrons) in the photodiode; the integration of charges may begin only after the end of the signal GSH;
after the end of the signal GSH, emission of a brief interline transfer signal TL which turns on the transistor T6; the photodiode PD is brought to the potential Vsi of the input Ei of the pixel and still cannot integrate any charges; the photodiode remains isolated at the end of the transfer signal TL and its potential is dictated by the voltage Vsi which was present on the input Ei at the end of the signal TL; everything happens as if a quantity of charge varying as a function of the potential Vsi present on the input Ei had been decanted into the photodiode; more precisely, the initial charge then taken by the photodiode, that is to say the quantity of charge thus fictitiously decanted is equal to the difference between the potential Vsi and an intrinsic potential Vpdi (pedestal potential) of the photodiode; this pedestal potential is the potential taken by the node N1 of the photodiode when it is completely drained of its charges;
integration of charges on the basis of this initial charge in the photodiode for the real integration duration which persists after the signals GSH and TL;
emission of a brief signal LRES which turns on the transistor T3 and brings the storage node N2 to the reference potential Vref; this signal is a signal for reinitializing the charges of the storage node N2 and is emitted at an arbitrary moment of the duration of integration, provided that it postdates the signal TL and predates the start of the signal GTRA which will follow and the end of which marks the end of the charge integration time;
emission of a brief transfer signal GTRA, which turns on the transistor T2 (for all the pixels) and transfers to node N2 the charge stored in the photodiode, which is then the sum of the initial charge and of the charge photogenerated during the integration time; transfer of the charge of the photodiode to the storage node is understood to mean an apportioning of the charges between nodes N1 and N2 in proportion to the respective capacitances of these two nodes, but in all cases the charge transferred to node N2 is proportional to the charge of the photodiode, still with the same proportionality coefficient;
after the end of the transfer signal GRA, a new signal GSH can be emitted.

Detailed Operation of the TDI Sensor:

The pixels of the first line are distinguished from the others in that their input Ei (drain of the transistor T6 controlled by the signal TL) is not linked to the output of a previous pixel but is linked to a fixed potential making it possible to completely drain the charges of the photodiode before the beginning of an integration time Te. Thus, when the actual exposure starts at the end of the signal TL, a photodiode of the first line is drained of its charges and will accumulate only the charges photogenerated in this line by a first observed image line.

At the second integration time, the sensor being displaced by a line of pixels, it is the second line of pixels which will receive the charges photogenerated by this same first image line. But the signal TL applied to the pixels of this second line causes the application to the photodiode of the voltage present at this moment on the output of the pixel of the first line, that is to say a voltage arising from the charge-voltage conversion of the quantity of charge present on the storage node N2. At the start of the second integration time the pixels of the second line take an initial charge dictated by the result of the integration in the first line and add thereto, in the course of the second integration time, charges photogenerated in their photodiodes.

It is possible to consider for simplicity that at the end of the second integration time, the charge present in the photodiode is a sum of the charges photogenerated by the first two lines over two integration times.

Henceforth, at the N^{th} integration time, the potential taken by a photodiode of the N^{th} line at the start of the integration time represents the equivalent of the presence of a charge accumulated over N−1 integration times by the first N−1 lines of the sensor; and at the end of the N^{th} integration time, the charge present in the photodiode (and then in the storage node N2) of the last line represents the equivalent of the charge accumulated over N integration times by the N lines of the sensor which have all observed the same image line. The voltage corresponding to this aggregate is transferred by the follower transistor T4 of the last line to the output register where it can be extracted, or else firstly converted into digital words and then extracted.

It was mentioned above that the input of the pixels of the first line is connected to a fixed voltage. This fixed voltage can be a power supply voltage Vdd, but for symmetry of operation, it is preferable for it to be generated by an arrangement such as that of the transistors T3, T4 and T5: a reference voltage Vref (the same as previously) is applied by a first transistor (equivalent of T3) to the gate of a follower transistor (equivalent of T4) charged by a current source (equivalent of T5). In this way, the initial voltage taken by the photodiodes of the first line is the same as the initial voltage that would be taken by the photodiodes of an arbitrary line in the total absence of illumination.

In order for the sensor to operate best, it is desirable for the reference voltage Vref which serves to reinitialize the potential of the storage node N2 to be chosen in a particular manner: if the gate-source voltage drop of the transistor T4 connected to the current source T5 is called Vgs, then it is preferable for Vref to be chosen equal to Vpdi+Vgs, Vpdi being the pedestal voltage (mentioned above) of the photodiode PD. This pedestal voltage, which is the voltage across the terminals of the photodiode empty of charges, depends on the technology and can for example be of the order of 1 to 2 volts.

In the charge transfers mentioned previously and in the charge-voltage conversions which are performed, it will be noted that the transfer efficiency or the conversion gain is not necessarily unitary, thus implying that the progressive accumulation of charges in a storage node of the N^{th} line is not exactly the sum of the charges photogenerated in the N lines.

For example, it may be considered that there is a non-unitary gain in the follower circuit T4, T5. Moreover, the ratio between the capacitance value Cd of the photodiode which accumulates the charges and the capacitance value Cm of the storage node is also involved (in the ratio of these capacitances) in defining the ratio between the charges transferred and the voltage taken by the storage node.

In total, the gain of the stage between the charge present in the photodiode of a stage at the end of an integration time and the equivalent charge applied to the photodiode of the following line at the start of the following integration time is of the form

G=Gt.Cd/Cm where Gt is the gain of the follower circuit.

It is desirable for this gain G to be as close as possible to 1 to perform the equivalent of an accumulation of charges on N lines.

The invention has been described with regard to a pixel structure with six transistors (including the transistor T5 forming a current source). But it is also usable for example with a pixel with five transistors, the exposure time adjustment transistor T1 being purely and simply omitted.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. A linear image sensor, of the travelling and integration type, allowing the synchronized readout of one and the same linear image successively by N lines of P photosensitive pixels and the pixel by pixel summation of signals arising from the readout of the various lines, during successive integration periods, in correspondence with the travelling of the linear image past the N lines of pixels, a pixel being built up of a circuit with MOS transistors comprising at least one photodiode, a charge storage node, an on/off switch for transferring the charge of the photodiode to the storage node at the end of an integration period, an on/off switch for reinitializing the charge of the storage node before this transfer, and a charge-voltage conversion circuit for applying a voltage representing the charge stored on the storage node to an output of the pixel, wherein a pixel of rank j in a line of intermediate rank i has its output linked to an input of the pixel of rank j of the line of immediately higher rank i+1, and comprises an input linked to an output of the pixel of rank j of the line of immediately lower rank i−1, with an on/off switch between the input and the photodiode for applying to the photodiode, before charge integration, the voltage present at the input of the pixel.

2. The linear image sensor according to claim 1, wherein the charge-voltage conversion circuit comprises a first transistor whose gate is linked to the storage node and whose source is linked to the output of the pixel, and a second transistor arranged as a current source, linked to the source of the first transistor.

3. The linear image sensor according to claim 2, wherein the on/off switch for reinitializing the charge of the storage node is linked to a reference voltage whose value is equal to the sum of the gate-source voltage drop of the first transistor of the charge-voltage conversion circuit and of the voltage appearing across the terminals of the photodiode when the latter is empty of charges and isolated.

4. The linear image sensor according to claim 1, wherein the pixel comprises a transistor linked between the photodiode and a power supply voltage so as to link the photodiode to the potential of this power supply during a fraction of the charge integration period and prevent during this fraction the integration of charges in the photodiode.

5. Method of image capture, of the travelling and signal-integrating type, for the synchronized readout of one and the same image line successively by N lines of P photosensitive pixels and the pixel by pixel summation of signals arising from the readout of the various lines, during successive integration periods, in correspondence with the travelling of the linear image past the N lines of pixels, a pixel being built up of a circuit with MOS transistors comprising at least one photodiode, a charge storage node, and a charge-voltage conversion circuit for applying a voltage representing the quantity of charge stored in the storage node to an output of the pixel, wherein, at the start of an integration time for integrating photogenerated charges, the output voltage of a pixel of a previous line is applied to the photodiode of the pixel of an intermediate line of rank i, the photodiode is isolated, charges due to light are integrated therein, and finally, at the end of the integration time, the charges of the photodiode are transferred into the storage node.

6. Method according to claim 5, wherein the charge of the storage node is reinitialized to a fixed value before the charges are transferred from the photodiode into the storage node.

7. Method of image capture according to claim 5, wherein the charge-voltage conversion circuit comprises a first transistor whose gate is linked to the storage node, wherein the reinitialization of the charge of the storage node is performed by linking the storage node to a reference voltage whose value is equal to the sum of the gate-source voltage drop of the first transistor of the charge-voltage conversion circuit and of the voltage appearing across the terminals of the photodiode when the latter is empty of charges and isolated.

8. Method according to claim 5, comprising a step of connecting the diode to a power supply potential before the application to the photodiode of the output voltage of the pixel of the previous line, so as to link the photodiode to the potential of this power supply during a fraction of the charge integration period and prevent during this fraction the integration of charges in the photodiode.

9. Method according to claim 7, comprising a step of connecting the diode to a power supply potential before the application to the photodiode of the output voltage of the pixel of the previous line, so as to link the photodiode to the potential of this power supply during a fraction of the charge integration period and prevent during this fraction the integration of charges in the photodiode.

10. The linear image sensor according to claim 2, wherein the pixel comprises a transistor linked between the photodiode and a power supply voltage so as to link the photodiode to the potential of this power supply during a fraction of the charge integration period and prevent during this fraction the integration of charges in the photodiode.

11. The linear image sensor according to claim 3, wherein the pixel comprises a transistor linked between the photodiode and a power supply voltage so as to link the photodiode to the potential of this power supply during a fraction of the charge integration period and prevent during this fraction the integration of charges in the photodiode.

12. Method of image capture according to claim 6, wherein the charge-voltage conversion circuit comprises a first transistor whose gate is linked to the storage node, wherein the reinitialization of the charge of the storage node is performed by linking the storage node to a reference voltage whose value is equal to the sum of the gate-source voltage drop of the first transistor of the charge-voltage conversion circuit and of the voltage appearing across the terminals of the photodiode when the latter is empty of charges and isolated.

13. Method according to claim 6, comprising a step of connecting the diode to a power supply potential before the application to the photodiode of the output voltage of the pixel of the previous line, so as to link the photodiode to the potential of this power supply during a fraction of the charge integration period and prevent during this fraction the integration of charges in the photodiode.
